(19) United States
(12) Patent Application Publication
(10) Pub. No.: US 2018/0059310 A1
(43) Pub. Date: Mar. 1, 2018

(54) BACKLIGHT MODULE, DISPLAY DEVICE INCLUDING THE SAME, AND METHOD OF FABRICATING THE SAME

(71) Applicant: SAMSUNG DISPLAY CO., LTD., Yongin-si (KR)

(72) Inventors: Kwangsoo BAE, Yongin-si (KR); Donchan CHO, Yongin-si (KR); Youngje CHO, Yongin-si (KR)

(21) Appl. No.: 15/469,106

(22) Filed: Mar. 24, 2017

(30) Foreign Application Priority Data
Aug. 26, 2016 (KR) 10-2016-0109554

(51) Int. Cl. F21V 8/00; G02F 1/1335; G02F 1/1368; G02F 1/1362

(52) U.S. Cl. CPC G02B 6/0055; G02B 6/005; G02F 1/136286; G02B 6/0065; G02F 1/1368; G02F 1/133528

(57) ABSTRACT

A backlight module includes a light guide panel having a light output region and a light blocking region, a light source that emits light to a side surface of the light guide panel, a color layer disposed over the light output region that transmits colored light, a planarization layer that covers the color layer on the light guide panel, and an air gap provided between the light blocking region and the planarization layer.

### CROSS-REFERENCE TO RELATED APPLICATION

This application claims priority under 35 U.S.0 § 119 from, and the benefit of, Korean Patent Application No. 10-2016-0109554, filed on Aug. 26, 2016 in the Korean Intellectual Property Office, the contents of which are herein incorporated by reference in their entirety.

### BACKGROUND

### 1. Technical Field

One or more exemplary embodiments are directed to to a backlight module, a display device including the backlight module, and a method of fabricating the backlight module, and more particularly, to a backlight module that respectively emits color light corresponding to pixels.

### 2. Description of the Related Art

A liquid crystal display device is a widely-used display device and includes a pixel electrode, a common electrode, and a liquid crystal layer between the pixel electrode and common electrode. An electric field is generated in the liquid crystal layer by applying a voltage between the pixel electrode and common electrode, and liquid crystal molecules of the liquid crystal layer are oriented according to a magnitude of the electric field. Pixels of the liquid crystal display device display an image by adjusting the brightness of light emitted from a backlight module that is polarized by the oriented liquid crystal molecules.

A liquid crystal display device includes color filters to form a color image, and when light emitted from a backlight module passes through one of a red color filter, a green color filter, and a blue color filter, the light intensity is reduced by about ⅓ due by each of the red, green, and blue color filters, thereby reducing light efficiency. Furthermore, some of light emitted from the backlight module is absorbed into a light blocking region between the color filters. Therefore, light efficiency is reduced and power consumption increases.

### SUMMARY

One or more exemplary embodiments include a backlight module that can prevent a decrease in light efficiency of the backlight module and a display device including the same.

One or more exemplary embodiments include a backlight module that can increase color reproducibility while having simplified fabrication processes, and a display device including the same.

According to one or more exemplary embodiments, a backlight module includes a light guide panel having a light output region and a light blocking region, a light source that emits light to a side surface of the light guide panel, a color layer disposed over the light output region that transmits colored light, a planarization layer that covers the color layer on the light guide panel, and an air gap provided between the light blocking region and the planarization layer.

The air gap may be provided directly on the light blocking region and surrounds side surfaces of the color layer.

The backlight module may further include an interface layer that includes a first portion between the air gap and the color layer and a second portion between the air gap and the planarization layer, the interface layer delimiting side surfaces and an upper surface of the air gap. The second portion of the interface layer may have a through hole, and the planarization layer may directly contact the air gap through the through hole.

The interface layer may further include a third portion between the color layer and the light output region.

The first portion of the interface layer may be tilted so that the color layer has a reverse-tapered section and a width of the first portion increases with increasing distance from the light guide panel.

The backlight module may further include a reflective layer disposed between the first portion of the interface layer and the color layer and over the first and second portions of the interface layer.

The light emitted from the light source may be white light, and the color layer may transmit colored light by absorbing wavelength bands of the white light incident thereon not being transmitted.

Light emitted from the light source may have a first peak wavelength, and the color layer may include a color conversion layer having a plurality of quantum dots excited by first peak wavelength light and that emit colored light having a second peak wavelength longer than the first peak wavelength, and a filter layer located between the color conversion layer and the planarization layer that absorbs the first peak wavelength light and transmits colored second peak wavelength light.

The first peak wavelength light may be blue light or ultraviolet light.

The light output region may include first through third regions, the color layer may include a first color layer on the first region that transmits first colored light, a second color layer on the second region that transmits second colored light, and a third color layer on the third region that transmits third colored light, and the air gap may be located between the first through third color layers.

According to one or more exemplary embodiments, a display device includes the backlight module, a pixel array portion disposed on the planarization layer that includes a pixel electrode that overlaps the light output region and a pixel circuit that transmits a gray scale voltage to the pixel electrode, a first polarizing plate on the planarization layer, a liquid crystal layer on the first polarizing plate, and a second polarizing plate on the pixel array portion.

According to one or more exemplary embodiments, a method of fabricating a backlight module includes forming a sacrificial pattern on a light guide panel, where the sacrificial pattern defines a light output region and a light blocking region on the light guide panel, forming an interface layer that covers the sacrificial pattern on the light guide panel, forming a through hole exposing an upper surface of the sacrificial pattern in the interface layer; and removing the sacrificial pattern through the through hole to form an air gap where side surfaces and an upper surface of the air gap are delimited by the interface layer.

The method may further include forming a color layer that emits colored light from light incident on the light output region, forming a planarization layer on the color layer, wherein the planarization layer is formed of a high viscosity organic material that does not flow into the air gap through the through hole, and providing a light source that emits light to a side surface of the light guide panel.

The color layer may be formed by an inkjet coating method in a trench on the light output region defined by where the interface layer covers the air gap

The method may further include forming a reflective layer on the interface layer that covers at least a side surface of the sacrificial layer.

According to one or more exemplary embodiments, a backlight module includes a light guide panel having a light output region and a light blocking region, a color layer disposed over the light output region that transmits colored light, an air gap disposed over the light blocking region, and an interface layer comprising a first portion between the air gap and the color layer and a second portion over the air gap, the interface layer delimiting side surfaces and an upper surface of the air gap.

The backlight module may further include a light source that emits light to a side surface of the light guide panel, and a planarization layer that covers the color layer on the light guide panel. The first portion of the interface layer may be tilted wherein the color layer has a reverse-tapered section and a width of the first portion increases with increasing distance from the light guide panel. The second portion of the interface layer may be disposed between the air gap and the planarization layer and has a through hole, and the planarization layer may directly contact the air gap through the through hole. A reflective layer may be disposed over the first and second portions of the interface layer.

The interface layer may further include a third portion between the color layer and the light output region.

Light emitted from the light source may be white light, and the color layer may transmit colored light by absorbing wavelength bands of the white light incident thereon not being transmitted

Light emitted from the light source may have a first peak wavelength. The color layer may include a color conversion layer with a plurality of quantum dots excited by the first peak wavelength light and that emit colored light having a second peak wavelength longer than the first peak wavelength, and a filter layer located between the color conversion layer and the planarization layer. The filter layer may absorb the first peak wavelength light and transmit colored second peak wavelength light.

### BRIEF DESCRIPTION OF THE DRAWINGS

FIG. 1 is a cross-sectional view of the structure of a display device according to an exemplary embodiment,

FIG. 2 is a plan view of a light guide panel of a backlight module according to an exemplary embodiment.

FIG. 3 is a perspective view of a light guide panel in which a display layer is provided over a light output region, according to an exemplary embodiment.

FIG. 4 is a perspective view of a part of a backlight unit according to an exemplary embodiment.

FIG. 5 is a cross-sectional view of a part of a backlight module according to an exemplary embodiment.

FIG. 6 is a cross-sectional view of a part of a backlight module according to another exemplary embodiment.

FIG. 7 is an enlarged view of a color layer of FIG. 6.

FIGS. 8A through 8G are cross-sectional views that illustrate a method of fabricating a backlight module of FIG. 6, according to an exemplary embodiment.

FIG. 9 is a cross-sectional view of a part of a backlight module according to another exemplary embodiment.

### DETAILED DESCRIPTION

Reference will now be made in detail to exemplary embodiments, examples of which are illustrated in the accompanying drawings, wherein like reference numerals may refer to like elements throughout. In this regard, the present exemplary embodiments may have different forms and should not be construed as being limited to the descriptions set forth herein.

It will be understood that when a layer, region, or component is referred to as being “formed on” another layer, region, or component, it can be directly or indirectly formed on the other layer, region, or component. Sizes of elements in the drawings may be exaggerated for convenience of explanation.

It will be understood that when a layer, region, or component is connected to another portion, the layer, region, or component may be directly connected to the portion or an intervening layer, region, or component may exist.

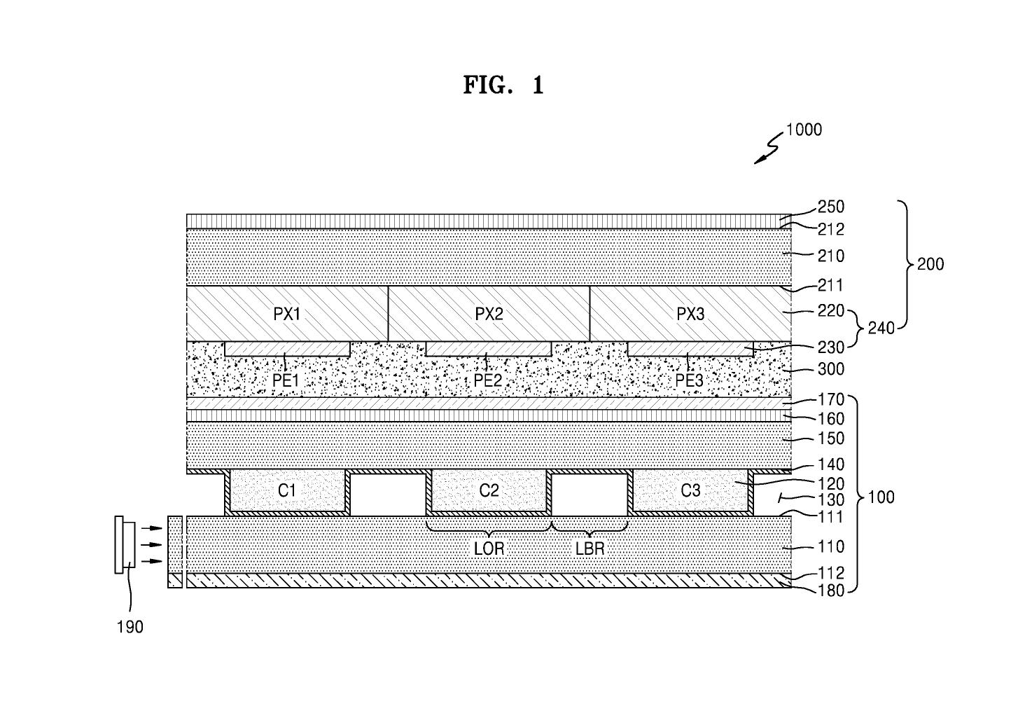

FIG. 1 is a cross-sectional view of the structure of a display device 1000 according to an exemplary embodiment.

Referring to FIG. 1, the display device 1000 includes a backlight module 100, a pixel array module 200, and a liquid crystal layer 300.

According to an embodiment, backlight module 100 includes a light guide panel 110, a light source 190, a color layer 120, an air gap 130, and a planarization layer 150. The light guide panel 110 includes a light output region LOR and a light blocking region LBR. The light source 190 emits light to a side surface of the light guide panel 110. The color layer 120 is provided over the light output region LOR and transmits colored light. The planarization layer 150 is provided over the light guide panel 110 to cover the color layer 120. The air gap 130 is provided between the light blocking region LBR and the planarization layer 150.

According to an embodiment, the backlight module 100 further includes at least one of an interface layer 140, a first polarizing plate 160, a common electrode 170, and a reflection plate 180. The first polarizing plate 160 is provided over the planarization layer 150.

According to an embodiment, the pixel array module 200 includes a pixel array portion 240 on a first surface 211 of an upper substrate 210. The pixel array portion 240 includes a pixel electrode 230 that overlaps the light output region LOR, and a pixel circuit 220 that drive the pixel electrode 230. The pixel array module 200 further includes a second polarizing plate 250 on a second surface 212 of the upper substrate 210.

According to an embodiment, the liquid crystal layer 300 is disposed between the backlight module 100 and the pixel array module 200. The liquid crystal layer 300 includes liquid crystal molecules oriented along an electric field between the pixel electrode 230 and the common electrode 170, and the display device 1000 may be referred to as a liquid display device.

According to an embodiment, the light guide panel 110 includes a first surface 111 and a second surface 112 that face each other. The light output region LOR and the light blocking region LBR are on the first surface 111. The light output region LOR outputs light and the light blocking region LBR does not output light. The display device 1000 includes a plurality of pixels arranged in a matrix form to display an image, in which the light output region LOR corresponds to a pixel and the light blocking region LBR corresponds to a region between pixels. The light output region LOR includes a plurality of pixel regions surrounded by the light blocking region LBR.

According to an embodiment, the light guide panel 110 is formed of a transparent material having a predetermined refractive index, such as glass, quartz, or a polymer, to efficiently guide light. The polymer can include, for example, a material selected from a group formed of polymethylmethacrylate (PMMA), polycarbonate (PC), polyacrylate (PA), polyurethane, an olefin-based transparent resin, or a combination thereof, but embodiments of the inventive concept are not limited thereto. For example, when a PMMA material having excellent weatherability is used for the light guide panel 110, the light guide panel 110 is resilient to cracking or deformation due to the high mechanical strength of a PMMA material, and has excellent transparency, gloss, and chemical resistance, and a low light absorptivity in a visible light region.

According to an embodiment, the light source 190 is provided beside the light guide panel 110 and emits light to a side surface of the light guide panel 110. The light source 190 may be provided adjacent to any one side surface, adjacent to two side surfaces that face each other, or to every side surface of the light guide panel 110. FIG. 1 shows that the light source 190 is adjacent to one side surface of the light guide panel 110, but embodiments of the inventive concept are not limited thereto.

According to an embodiment, the light source 190 includes, e.g., a light-emitting diode (LED). The light source 190 further includes a printed circuit board (PCB) on which LEDs are mounted to face a side surface of the light guide panel 110.

According to other embodiments, the light source 190 includes a cold cathode fluorescent lamp (CCFL) or an external electrode fluorescent lamp (EEFL). In this case, the light source 190 further includes a housing to reflect light emitted from these lamps.

According to an embodiment, the light source 190 can emit white light, blue light, or ultraviolet (UV) light, based on the color layer 120. Light emitted from the light source 190 propagates in a side direction through the light guide panel 110, and is emitted toward the pixel array module 200 through the light output region LOR. When light propagating in the light guide panel 110 is incident on the light blocking region LBR, the light is reflected, but not absorbed, by the light blocking region LBR.

According to an embodiment, the color layer 120 is provided over the light output region LOR of the light guide panel 110, and absorbs light incident thereon through the light guide panel 110 and emits color light.

According to an exemplary embodiment, the color layer 120 functions as a color filter, and outputs colored light by allowing only light in some wavelength bands to pass therethrough and reflecting or absorbing light in the other wavelength bands, from light emitted from the light source 190. The light source 190 output white light that includes wavelengths in all visible light bands, and the color layer 120 outputs red light, green light, or blue light based on the color of a corresponding pixel.

According to another exemplary embodiment, the color layer 120 emits colored light having a wavelength longer than that of light emitted from the light source 190 and incident thereon. The color layer 120 can include quantum dots that correspond to a color of a corresponding pixel. For example, the light source 190 emits blue light, the color layer 120 corresponding to a red pixel includes quantum dots that are excited by blue light and emit red light, and the color layer 120 corresponding to a green pixel includes quantum dots that are excited by blue light and emit green light. The color layer 120 corresponding to a blue pixel outputs blue light as is.

For example, the light source 190 emits UV light. According to an embodiment, the color layer 120 corresponding to a red pixel includes quantum dots that are excited by UV light and emit red light, the color layer 120 corresponding to a green pixel includes quantum dots that are excited by UV light and emit green light, and the color layer 120 corresponding to a blue pixel includes quantum dots that are excited by UV light and emit blue light.

According to an embodiment, the air gap 130 is provided over the light blocking region LBR of the light guide panel 110. The air gap 130 is provided directly on the light blocking region LBR and surrounds side surfaces of the color layer 120. A refractive index of the air gap 130 is approximately 1 because the air gap 130 is filled with air. On the other hand, when the light guide panel 110 is formed of, e.g., a PMMA material, a refractive index of the light guide panel 110 is approximately 1.5. Since light emitted from the light source 190 propagates through the light guide panel 110 in a side direction, the angle of incidence of light on an interface between the air gap 130 and the light guide panel 110 is 45 degrees or more. When a refractive index of the light guide panel 110 is approximately 1.5, a critical angle for generating total internal reflection is approximately 42 degrees. Therefore, the light incident on the interface between the air gap 130 and the light guide panel 110 is reflected and propagates again through the light guide panel 110. The first surface 111 of the light guide panel 110 is coated with a material having a high refractive index, such as silicon nitride, to increase a refractive index difference between the air gap 130 and the light guide panel 110.

According to an embodiment, the planarization layer 150 is provided over the color layer 120 and the air gap 130 to provide a flat surface. The planarization layer 150 is formed of a transparent material to transmit color light output from the color layer 120. The planarization layer 150 can be formed of a transparent organic material, such as a polyimide resin, an acryl resin, or a resist material. The planarization layer 150 can be formed by a wet method, such as a slit coating method or a spin coating method, or a dry method, such as a chemical vapor deposition (CVD) method or a vacuum deposition method. However, materials of and methods for forming the planarization layer 150 are not limited thereto,

According to an embodiment, the interface layer 140 is provided to delimit the air gap 130. The interface layer 140 mis provided on side surfaces and an upper surface of the air gap 130. The interface layer 140 is disposed between the color layer 120 and the light guide panel 110. The interface layer 140 is formed of an inorganic material. In addition, a reflective layer can be disposed between the color layer 120 and the air gap 130. The reflective layer can be arranged between the interface layer 140 and the color layer 120. The reflective layer includes a reflective metal or a metal oxide, such as titanium oxide, silver, aluminum, or zinc oxide. The reflective layer can prevent color mixing of light that is horizontally emitted from the color layer 120.

According to an embodiment, the reflection plate 180 is disposed over the second surface 112 of the light guide panel 110 to prevent emission of light propagating through the light guide panel 110 from the second surface 112. The reflection plate 180 is formed of a reflective inorganic material, such as a metal or a metal oxide. Furthermore, a reflective material, such as ink, paste, white paint that stimulates light reflection, or gold or silver color that is bright and similar to white can be printed on the reflection plate 180.

According to an embodiment, the first polarizing plate 160 is provided over the planarization layer 150 to polarize color light emitted from the color layer 120. The first polarizing plate 160 transmits only colored light polarized in a specific direction, such as a first direction, from colored light emitted from the color layer 120.

According to an embodiment, the common electrode 170 is provided over the first polarizing plate 160 to generate an electric field in the liquid crystal layer 300. The common electrode 170 is formed of a transparent conductive material.

According to an embodiment, the upper substrate 210 is formed of glass or a transparent plastic material. The pixel circuits 220 are arranged in a matrix form on the first surface 211 of the upper substrate 210. The second polarizing plate 250 is provided on the second surface 212 of the upper substrate 210. The second polarizing plate 250 transmits light in a second direction perpendicular to the first direction. However, an exemplary embodiment is not limited thereto, and a polarization direction of the second polarizing plate 250 can be the same as that of the first polarizing plate 160.

According to an embodiment, the pixel circuit 220 includes one more thin-film transistors, and a gate wire and a data wire for respectively transmitting a gate signal and a data signal to each of the thin-film transistors. As illustrated in FIG. 1, the pixel circuit 220 includes a first pixel circuit PX1, a second pixel circuit PX2, and a third pixel circuit PX3. The first through third pixel circuits PX1 to PX3 can be sequentially arranged or have a preset arrangement.

According to an embodiment, the pixel electrode 230 is connected to a source or drain electrode of the thin-film transistor of the pixel circuit 220, and a gray-scale voltage is applied to the pixel electrode 230. The pixel circuit 220 transmits a gray scale voltage to the pixel electrode 230, The pixel electrode 230 includes a first pixel electrode PE1 that receives a gray scale voltage from the first pixel circuit PX1, a second pixel electrode PE2 that receives a gray scale voltage from the second pixel circuit PX2, and a third pixel electrode PE3 that receives a gray scale voltage from the third pixel circuit PX3.

According to an embodiment, the color layer 120 includes a first color layer C1 that overlaps the first pixel electrode PE1, a second color layer C2 that overlaps the second pixel electrode PE2, and a third color layer C3 that overlaps the third pixel electrode PE3. The first color layer C1 emits red light toward the first pixel electrode PE1, the second color layer C2 emits green light toward the second pixel electrode PE2, and the third color layer C3 emits blue light toward the third pixel electrode PE3. The air gap 130 is provided between the first through third color layers C1 to C3.

According to an embodiment, colored light emitted from the color layer 120 is polarized while passing through the first polarizing plate 160. An electric field is induced between the pixel electrode 230 and the common electrode 170 by a gray scale voltage transmitted to the pixel electrode 230, and the electric field changes an orientation direction of liquid crystal molecules in the liquid crystal layer 300 between the pixel electrode 230 and the common electrode 170. The polarization direction of colored light polarized by the first polarizing plate 160 changes while passing through the liquid crystal layer 300 due to the orientation direction of liquid crystal molecules. Only a portion of the colored light, whose polarization direction is adjusted by the liquid crystal layer 300, is transmitted through the second polarizing plate 250, due to the polarization direction of the second polarizing plate 250. Thus, only light having a predetermined brightness is emitted outward. A color image can be displayed when colored light emitted by each of the first through third color layers C1 to C3 has a brightness set by each of the first through third pixel circuits PX1 to PX3.

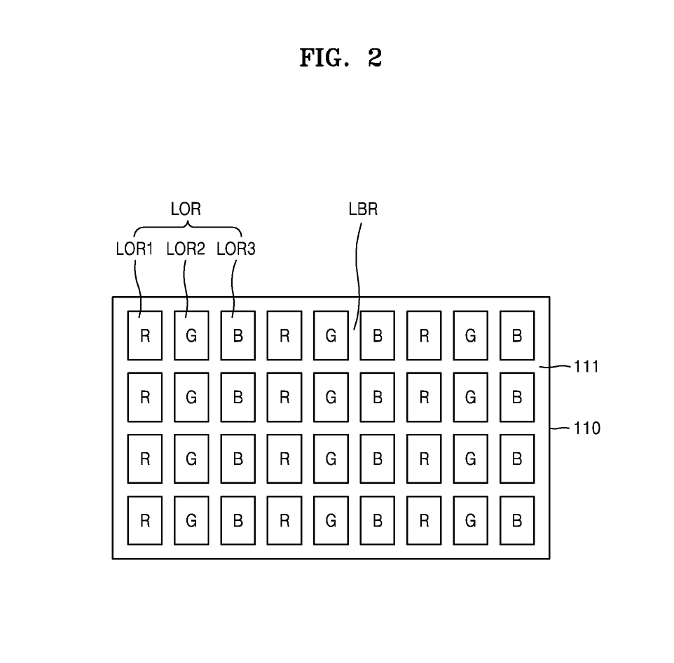

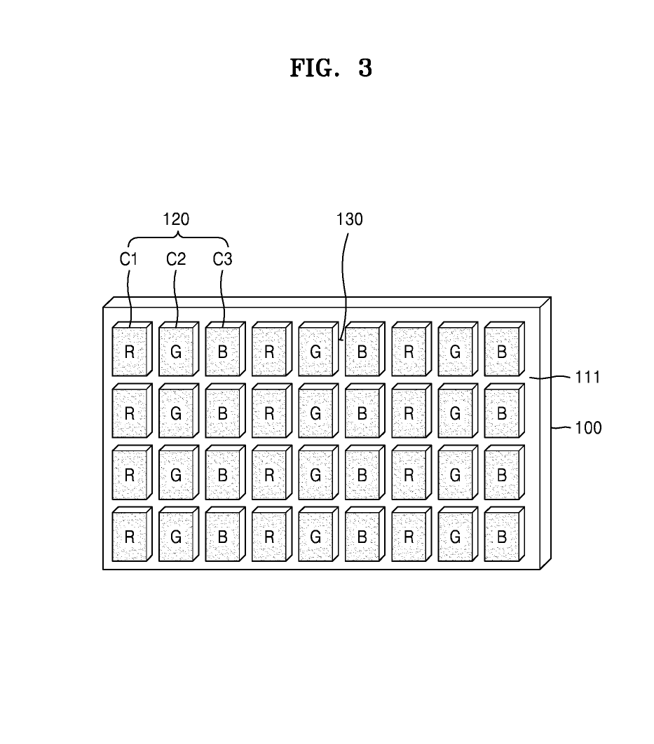

FIG. 2 is a plan view of the light guide panel 110 of the backlight module 100, according to an exemplary embodiment. FIG. 3 is a perspective view of the light guide panel 110 in which a display layer is provided over a light output region, according to an exemplary embodiment.

According to an embodiment, FIG. 2 shows the light output region LOR and the light blocking region LBR on the first surface 111 of the light guide panel 110. The light output region LOR, from which light transmitted through the light guide panel 110 is emitted outward, corresponds to pixels that display an image, as illustrated in FIG. 1. The light output region LOR includes a first region LOR1, a second region LOR2, and a third region LOR3. First regions LOR1, second regions LOR2, and third regions LOR3 are arranged on the light guide panel 110 to correspond to an arrangement of pixels of the display device 1000. The plurality of first through third regions LOR1 to LOR3 are surrounded by the light blocking region LBR on the first surface 111 of the light guide panel 110. The first regions LOR1 correspond to red pixels of the display device 1000, the second regions LOR2 correspond to green pixels, and the third regions LOR3 correspond to blue pixels.

According to an embodiment, the light blocking region LBR, through which no light is emitted from the first surface 111, form a mesh on the first surface 111. The light blocking region LBR is a provided between the plurality of first through third regions LOR1 to LOR3. Light emitted toward the light blocking region LBR may leak from the display device 1000.

FIG. 3 shows the color layer 120 on the light output region LOR and the air gap 130 on the light blocking region LBR. Since a refractive index of the air filling the air gap 130 is approximately 1, as described above, light propagating from the light guide panel 110 into the air gap 130 is totally reflected by the interface between the air gap 130 and the light guide panel 110, and is not emitted outward, when an incident angle of the light is 45 degrees or more.

According to an embodiment, the color layer 120 includes the first color layer C1 on the first region LOR1, the second color layer C2 on the second region LOR2, and the third color layer C3 on the third region LOR3. The first color layer C1 emits red light, the second color layer C2 emits green light, and the third color layer C3 emits blue light. Red light has a peak wavelength equal to or greater than 580 nm and less than 750 nm. Green light has a peak wavelength equal to or greater than 495 nm and less than 580 nm. Blue light has a peak wavelength equal to or greater than 400 nm and less than 495 nm.

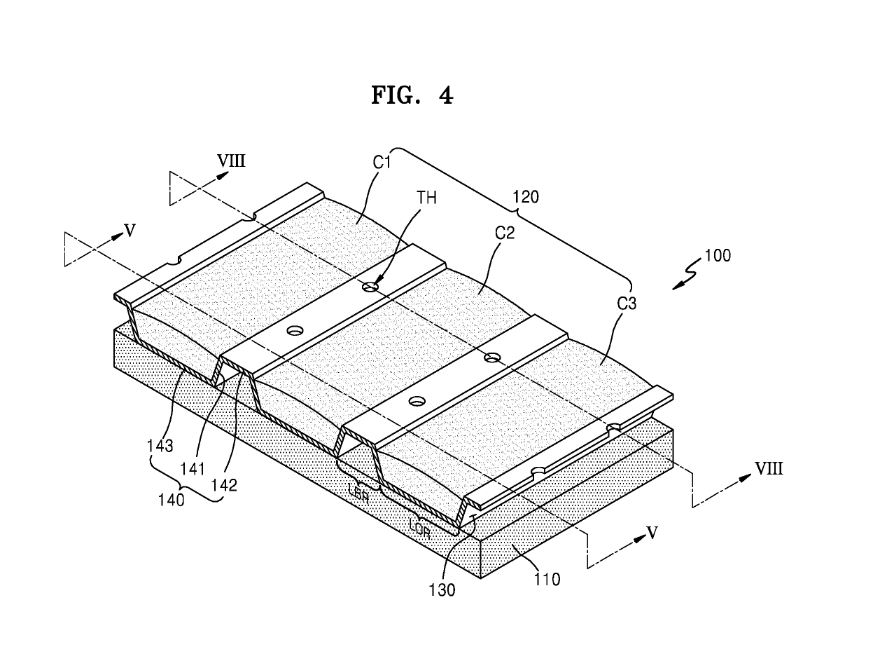

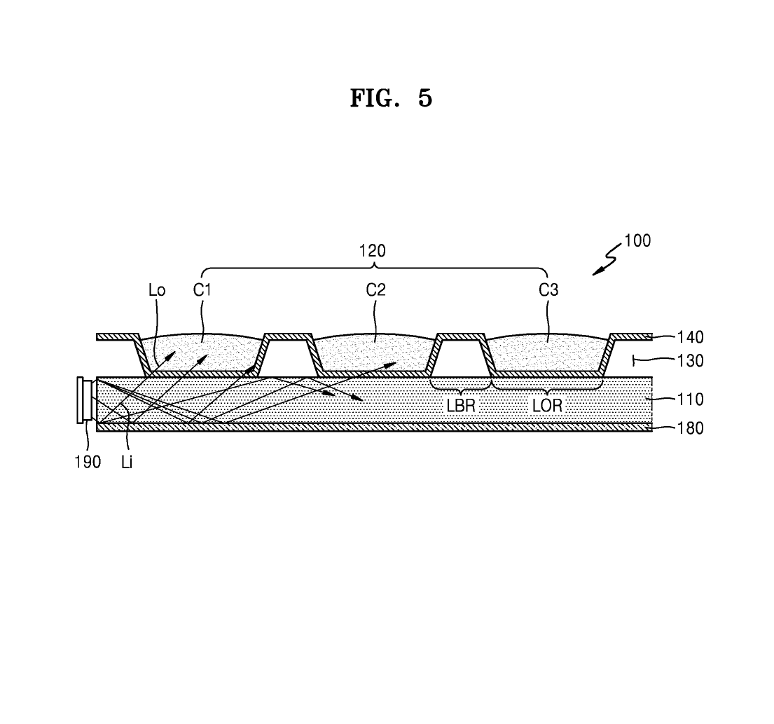

FIG. 4 is a perspective view of a part of a backlight unit according to an exemplary embodiment. FIG. 5 is a cross-sectional view of a part of a backlight module according to an exemplary embodiment.

Referring to FIGS. 4 and 5, the backlight module 100 includes the light guide panel 110, the light source 190, the color layer 120, the air gap 130, and the interface layer 140. A section of the backlight module 100 of FIG. 5 corresponds to a section taken along line V-V of FIG. 4.

According to an embodiment, the light guide panel 110 includes the light output region LOR and the light blocking region LBR. The light source 190 is provided adjacent to the light guide panel 110 and emits light Li to a side surface of the light guide panel 110. The light Li may be white light. The color layer 120 is disposed on the light output region LOR and emits colored light. The air gap 130 is provided on the light blocking region LBR. The air gap 130 is provided directly on the light blocking region LBR and surrounds side surfaces of the color layer 120. As illustrated in FIG. 1, the planarization layer 150 is disposed over the color layer 120 and the air gap 130.

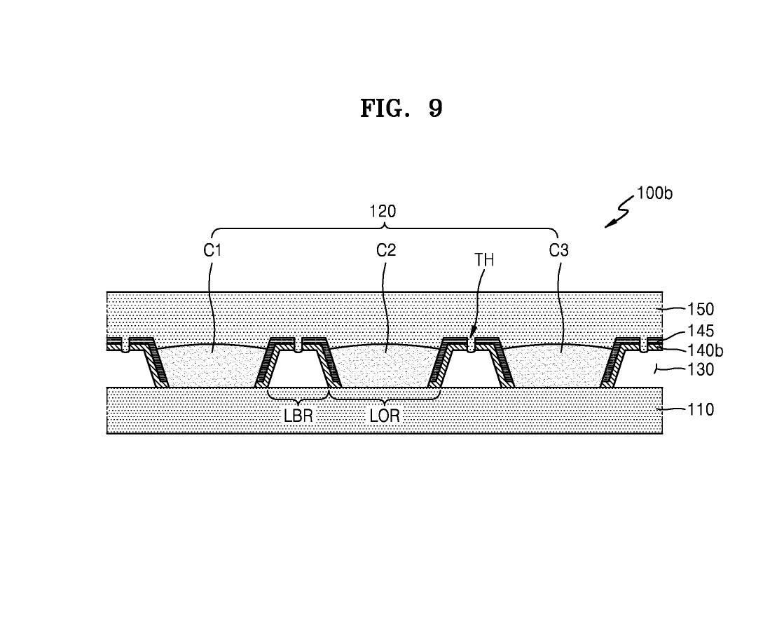

According to an embodiment, the interface layer 140 is disposed on side surfaces and an upper surface of the air gap 130 and delimits the air gap 130. The interface layer 140 includes a first portion 141 between the air gap 130 and the color layer 120 and a second portion 142 on the air gap 130. The first portion 141 of the interface layer 140 is tilted. For example, the first portion 141 can be tilted so that the color layer 120 has a reverse-tapered section and a width of the first portion 141 increases with increasing distance from the light guide panel 110. As illustrated in FIG. 4, the interface layer 140 further includes a third portion 143 between the color layer 120 and the light guide panel 110. As illustrated in FIG. 9, the third portion 143 may be omitted, depending on a fabrication process. The first through third portions 141 to 143 successively extend and form the interface layer 140.

According to an embodiment, the interface layer 140 provides a support structure that forms the air gap 130 as well as delimiting the air gap 130. A through hole TH is formed in the second portion 142 of the interface layer 140, and the air gap 130 is formed when a sacrificial pattern covered by the interface layer 140 is removed through the through hole TH.

According to an embodiment, the color layer 120 includes the first color layer C1 that emits red light, the second color layer C2 that emits green light, and the third color layer C3 that emits blue light.

According to an embodiment, the first color layer C1 includes a first color filter layer that allows red light to pass therethrough, and absorbs green light and blue light. The first color filter layer functions as a band-pass filter or a low-pass filter by allowing light in a red wavelength band to pass therethrough.

According to an embodiment, the second color layer C2 includes a second color filter layer that allows green light to pass therethrough and absorbs red light and blue light. The second color filter layer functions as a band-pass filter by allowing light in a green wavelength band to pass therethrough.

According to an embodiment, the third color layer C3 includes a third color filter layer that allows blue light to pass therethrough and absorbs red light and green light. The third color filter layer functions as a band-pass filter or a high-pass filter by allowing light in a blue wavelength band to pass therethrough.

As illustrated in FIG. 5, according to an embodiment, the light source 190 emits light Li to a side surface of the light guide panel 110. The emitted light Li propagates through the light guide panel 110. The emitted light Li horizontally propagates while being reflected between the first surface 111 and the second surface 112 of the light guide panel 110. Since the reflection plate 180 is disposed on the second surface 112, light Li arriving at the second surface 112 is reflected by the interface between the second surface 112 and the reflection plate 180. Light Li incident on the light output region LOR in the first surface 111 is incident on the color layer 120 through the interface layer 140. For example, the color layer 120 outputs colored light Lo by transmitting some of light incident thereon therethrough. Here, the color layer 120 functions as a color filter.

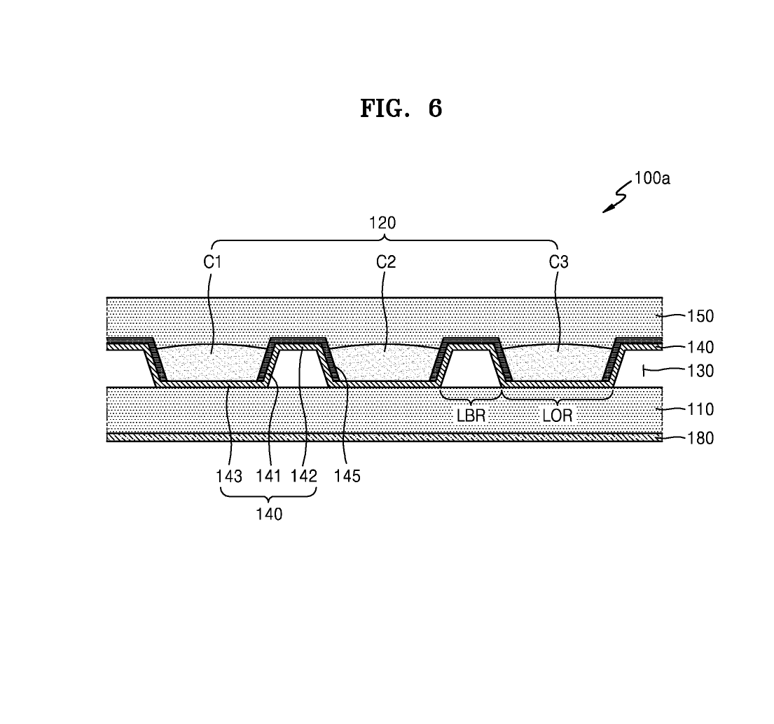

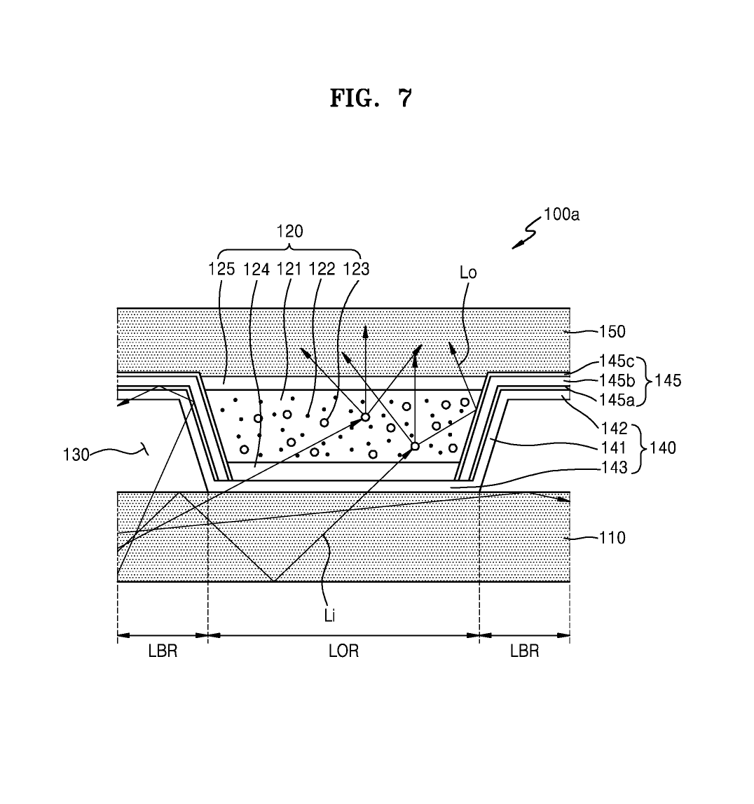

According to another exemplary embodiment, the color layer 120 is excited by light Li incident thereon and emits colored light Lo. Here, light Li may be blue light or UV light, and the color layer 120 functions as a color conversion layer or a wavelength conversion layer. However, since an angle of incidence of light Li on the light blocking region LBR in the first surface 111 is greater than a critical angle, light Li is totally reflected by an interface between the light guide panel 110 and the air gap 130 and propagates toward the second surface 112. A reflective layer may be provided over the first portion 141 of the interface layer 140. Colored light emitted to a side surface from quantum dots is reflected forward by the reflective layer, and thus improving light efficiency. This will be described later below in detail with reference to FIGS. 6 and 7.

FIG. 6 is a cross-sectional view of a part of a backlight module according to another exemplary embodiment. FIG. 7 is an enlarged view of the color layer 120 of FIG. 6.

Referring to FIGS. 6 and 7, according to an embodiment, a backlight module 100a includes the light guide panel 110, the light source 190, the color layer 120, the air gap 130, the planarization layer 150, the interface layer 140, and a reflective layer 145.

According to an embodiment, the light guide panel 110 includes the light output region LOR and the light blocking region LBR. As shown in FIG. 5, The light source 190 is provided adjacent to the light guide panel 110 and emits light Li to a side surface of the light guide panel 110. The color layer 120 is disposed on the light output region LOR and emits colored light. The air gap 130 is provided on the light blocking region LBR. The air gap 130 is provided directly on the light blocking region LBR and surrounds side surfaces of the color layer 120. The planarization layer 150 is disposed over the color layer 120 and the air gap 130.

According to an embodiment, the color layer 120 includes the first color layer C1 that emits red light, the second color layer C2 that emits green light, and the third color layer C3 that emits blue light. Light Li emitted from the light source 190 to the side surface of the light guide panel 110 may be blue light or UV light.

According to an embodiment, the first color layer C1 converts light Li into red light. The second color layer C2 converts light Li into green light. The third color layer C3 converts light Li into blue light or may output light Li as is when light Li is blue light. The color layer 120 may be referred to as a color conversion layer or a wavelength conversion layer. Colored light Lo emitted from the color layer 120 is emitted in a side direction or a rear direction as well as a forward direction.

According to an embodiment, the interface layer 140 provides a support structure that forms the air gap 130 and is provided on side surfaces and an upper surface of the air gap 130 to delimit the side surfaces and the upper surface of the air gap 130. The interface layer 140 includes the first portion 141 between the air gap 130 and the color layer 120 and the second portion 142 on the air gap 130. The first portion 141 is tilted so that the color layer 120 has a reverse-tapered section and a width of the first portion 141 increases with increasing distance from the light guide panel 110. The through hole TH is formed in the second portion 142 of the interface layer 140, and the air gap 130 is formed when a sacrificial pattern covered by the interface layer 140 is removed through the through hole TH.

As illustrated in FIG. 6, according to an embodiment, the interface layer 140 further includes the third portion 143 between the color layer 120 and the light guide panel 110. The first through third portions 141 to 143 successively extend and form the interface layer 140.

The reflective layer 145 is disposed between the air gap 130 and the color layer 120. The reflective layer 145 is disposed between the first portion 141 of the interface layer 140 and the color layer 120. As illustrated in FIG. 6, the reflective layer 145 is disposed between the second portion 142 of the interface layer 140 and the planarization layer 150. The reflective layer 145 on the second portion 142 of the interface layer 140 has a through hole TH that corresponds to a through hole TH of the second portion 142. According to another exemplary embodiment, the reflective layer 145 can be disposed below the first and second portions 141 and 142 of the interface layer 140, that is, between the first and second portions 141 and 142 and the air gap 130. The reflective layer 145 is not disposed between the color layer 120 and the light guide panel 110.

According to an embodiment, the reflective layer 145 prevents colored light Lo from being emitted toward and incident upon the adjacent color layer 120 in a side direction, and reflects colored light La emitted in a side direction in a forward direction. Thus, light efficiency can be improved.

According to an embodiment, the reflective layer 145 includes, e.g., a highly reflective metal layer. The metal layer may be formed of silver (Ag), magnesium (Mg), aluminum (Al), platinum (Pt), palladium (Pd), gold (Au), nickel (Ni), neodymium (Nd), iridium (Ir), chromium (Cr), an alloy thereof, or a compound thereof. For example, the reflective layer 145 includes a layer formed of Ag. The reflective layer 145 may have a multi-layer structure in which a plurality of layers are successively stacked. At least one of the plurality of layers includes a metal layer. For example, the reflective layer 145 includes a transparent metal oxide layer formed of indium tin oxide (ITO), and a Ag layer. For example, the reflective layer 145 includes a first transparent metal oxide layer, an Ag layer, and a second transparent metal oxide layer, which are successively stacked on each other.

According to an embodiment, light Li emitted from the light source 190 to the side surface of the light guide panel 110 propagates through the light guide panel 110. Light Li horizontally propagates while being reflected between the first surface 111 and the second surface 112 of the light guide panel 110. Since the reflection plate 180 is disposed on the second surface 112, light Li arriving at the second surface 112 is reflected by the interface between the second surface 112 and the reflection plate 180. Light Li incident on the light output region LCR in the first surface 111 is incident on the color layer 120 through the interface layer 140. According to an exemplary embodiment, the color layer 120 is excited by light Li incident thereon and emits colored light Lo. The color layer 120 may emit colored light Lo in a side direction, which is reflected forward by the tilted reflective layer 145.

According to an embodiment, since an angle of incidence of light Li on the light blocking region LBR in the first surface 111 is greater than a critical angle, light Li is totally reflected by the interface between the light guide panel 110 and the air gap 130 and propagates toward the second surface 112. Light Li incident on the light blocking region LBR with an incident angle less than a critical angle is reflected by the reflective layer 145 back into the light guide panel 110. Accordingly, light efficiency can be improved.

As illustrated in FIG. 7, according to an embodiment, the reflective layer 145 includes a first layer 145a, a second layer 145b, and a third layer 145c. The first layer 145a is disposed on the first and second portions 141 and 142 of the interface layer 140. The second layer 145b is directly formed on the first layer 145a and the third layer 145c is directly formed on the second layer 145b. The first layer 145a directly contacts the interface layer 140, and the third layer 145c directly contacts the color layer 120 and the planarization layer 150. The second layer 145b is interposed between the first layer 145a and the third layer 145c. The first layer 145a and the third layer 145c can be formed of, for example, a transparent metal oxide such as ITO, and the second layer 145b can be formed of a highly reflective metal, such as Ag. However, the materials and structure of the first through third layers 145a through 145c are not limited thereto.

According to an embodiment, the color layer 120 also includes a color conversion layer that includes a photosensitive resin 121 in which quantum dots 123 and scattered particles 122 are dispersed.

The quantum dots 123 emit colored light Lo after being excited by incident light Li. The quantum dots 123 absorb incident light Li and emit colored light Lo that has a wavelength band longer than that of the incident light Li. The quantum dots 123 include nano-crystals selected from Si-based nano-crystals, II-VI group-based compound semiconductor nano-crystals, III-V group-based compound semiconductor nano-crystals, IV-VI group-based compound semiconductor nano-crystals, or a mixture thereof. The II-VI group-based compound semiconductor nano-crystals can be selected from CdS, CdSe, CdTe, ZnS, ZnSe, ZnTe, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HggZnTe, CdZnSeS, CdZnSeTe, CdZnSTe, CdHgSeS, CdHgSeTe, CdHgSTe, HgZnSeS, HgZnSeTe, and HgZnSTe. The III-V group-based compound semiconductor nano-crystals can be selected from GaN, GaP, GaAs, AlN, AlP, AlAs, InN, InP, InAs, GaNP, GaNAs, GaPAs, AlNP, AlNAs, AlPAs, InNP, InNAs, InPAs, GaAlNP, GaAlNAs, GaAlPAs, GaInNP, GaInNAs, GaInPAs, InAlNP, InAlNAs, and InAlPAs. The IV-VI group-based compound semiconductor nano-crystals may be SbTe.

According to an embodiment, the quantum dots 123 included in the first color layer C1 that emit red light and the quantum dots 123 included in the second color layer C2 that emit green light can be formed of an identical material. However, a size of the quantum dot 123 included in the second color layer C2 differs from a size of the quantum dot 123 included in the first color layer C1 When a wavelength of emitted light increases, a size of the quantum dot 123 for sufficiently inducing surface plasmon resonance tends to increase. Accordingly, since the wavelength of green light is shorter than that of red light, the quantum dot 123 included in the second color layer C2 is smaller than the quantum dot 123 included in the first color layer C1.

According to an embodiment, when the incident light Li is UV light, quantum dots 123 included in the third color layer C3 that absorb UV light and emit blue light are formed of the same material as the quantum dots 123 included in the first color layer C1 and the quantum dots 123 included in the second color layer C2. However, the quantum dots 123 included in the third color layer C3 are smaller than the quantum dots 123 included in the second color layer C2.

According to an embodiment, the scattered particles 122 scatter light Li not absorbed by the quantum dots 123, and thus more quantum dots 123 can be excited by light Li. Thus, the color conversion efficiency of a color conversion layer can be increased by the scattered particles 122. The scattered particles 122 are not limited thereto, and can be titanium oxide (TiO₂) or metal particles. The photosensitive resin 121 can be a silicon resin or an epoxy resin, and is transparent.

According to another exemplary embodiment, the color conversion layer includes a fluorescent substance that converts the incident light Li into colored light Lo.

According to an embodiment, light Li incident on the color layer 120 can be blue light, that is, light in which a peak wavelength is located in a blue wavelength band. The color layer 120 includes a band-pass filter layer 124 that selectively transmits light Li incident between the color conversion layer and the light guide panel 110. When incident light Li includes different colored light, the different colored light is unable to excite the quantum dots 123 in the color layer 120 and propagates through the light guide panel 110. In this case, the color layer 120 emits not only light Lo emitted by the quantum dots 123 but also different colored light mixed in with light Li, and can decrease color purity and reduce color reproducibility. The band-pass filter layer 124 selectively transmits only the incident light Li, such as blue light, thereby increasing color purity and color reproducibility. According to another exemplary embodiment, the band-pass filter layer 124 is omitted.

According to an embodiment, when light Li incident onto the color layer 120 is UV light, the band-pass filter layer 124 transmits UV light and reflects color light Lo in a visible light band generated by the color layer 120.

According to an embodiment, the color layer 120 further includes a band-pass filter layer 125 that reflects light Li incident between the color conversion layer and the planarization layer 150. The filter layer 125 reflects incident light Li so that more quantum dots 123 are excited. Also, the filter layer 125 can block incident light Li from propagating through the planarization layer 150 to be emitted outward, thereby increasing color purity and color reproducibility.

According to an exemplary embodiment, when incident light Li is blue light, the filter layer 125 is a blue light blocking filter. When incident light Li is UV light, the filter layer 125 is a UV light blocking filter and prevents harmful UV light from being emitted outward. According to another exemplary embodiment, the filter layer 125 is a band-pass filter that selectively transmits colored light Lo generated in the color layer 120. When incident light Li includes different colored light, the filter layer 125 can block not only incident light Li but also different colored light such that no different colored light is emitted outward.

According to an embodiment, when incident light Li is blue light, the third color layer C3 that emits blue light does not include quantum dots. The third color layer C3 includes a light-transmitting layer that includes the photosensitive resin 121 in which the scattered particles 122 are dispersed, but without quantum dots. In this case, the third color layer C3 includes a band-pass filter layer that selectively transmits blue light.

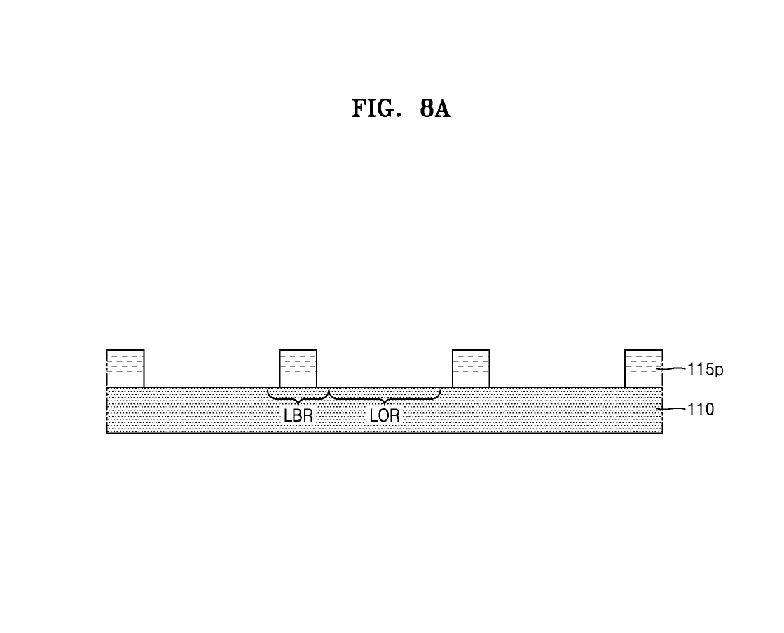

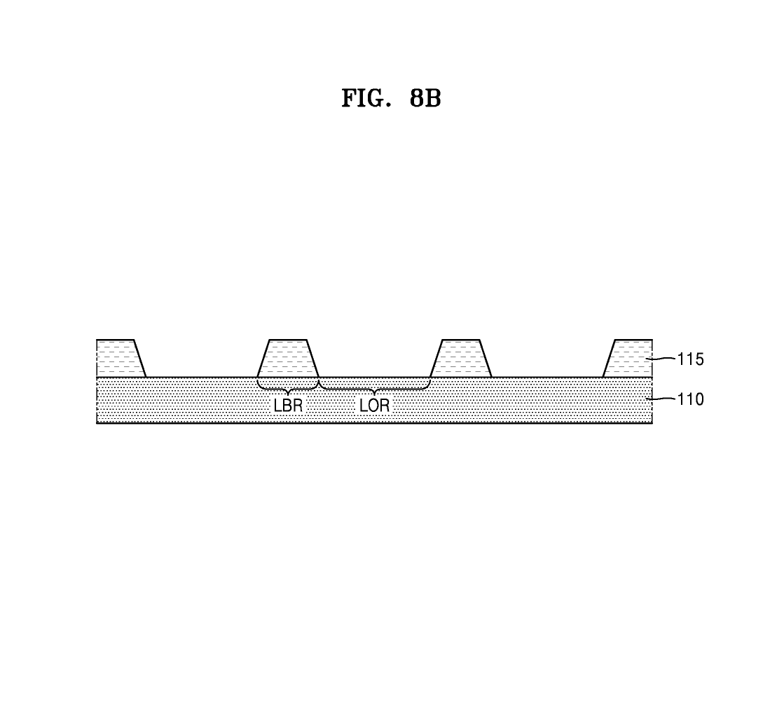

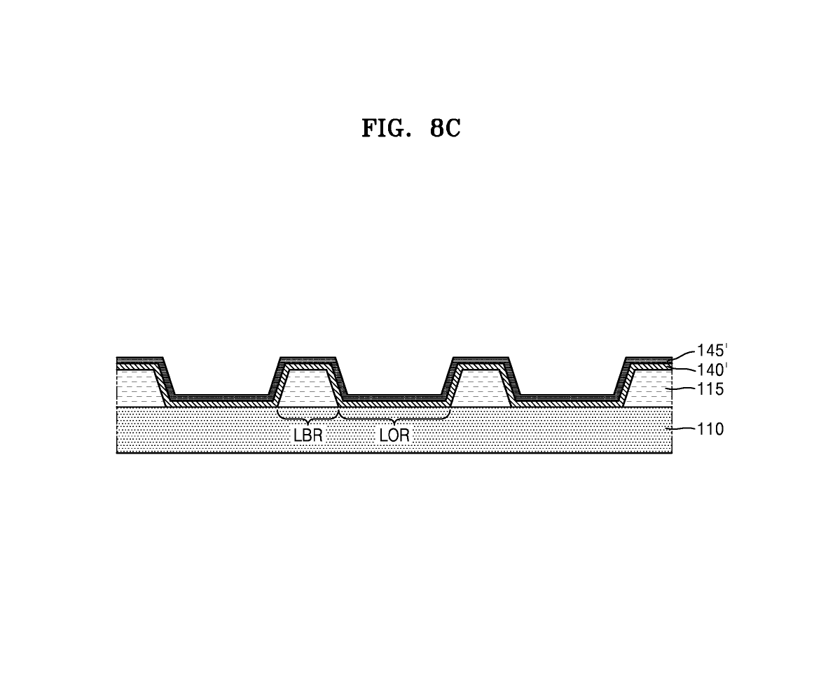

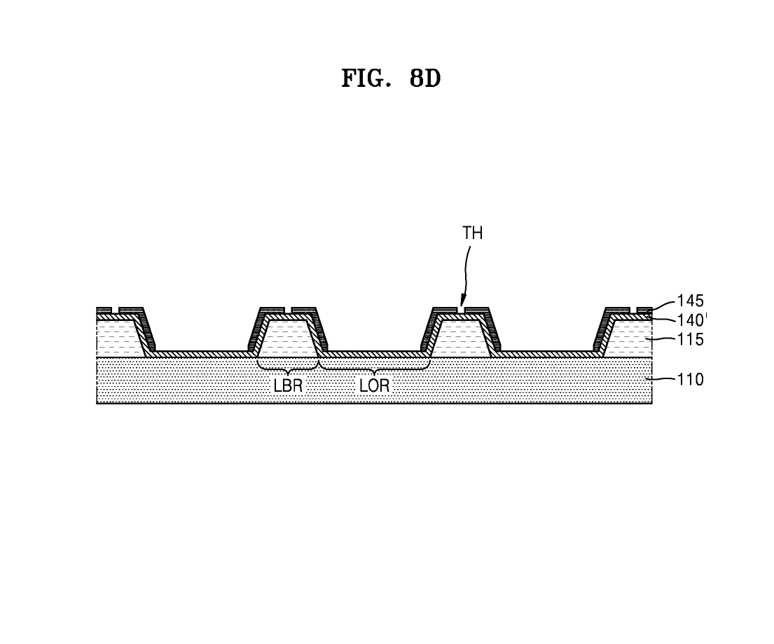

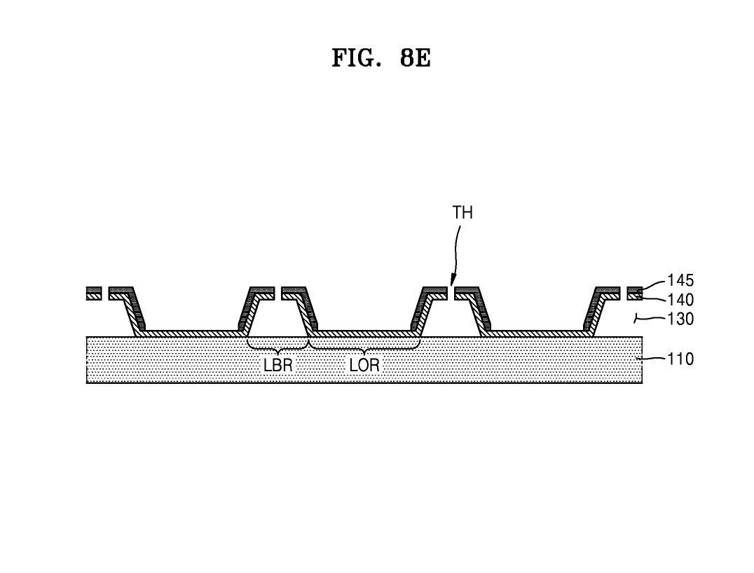

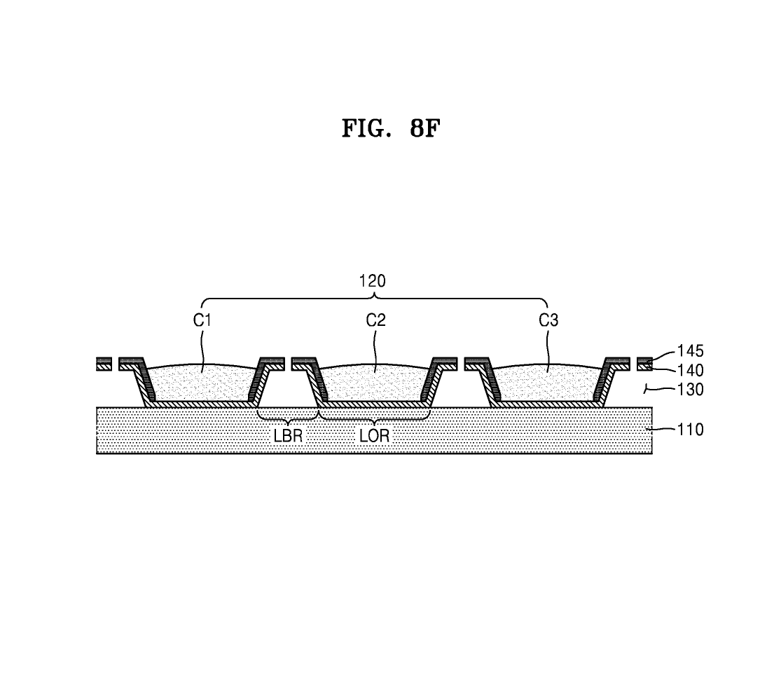

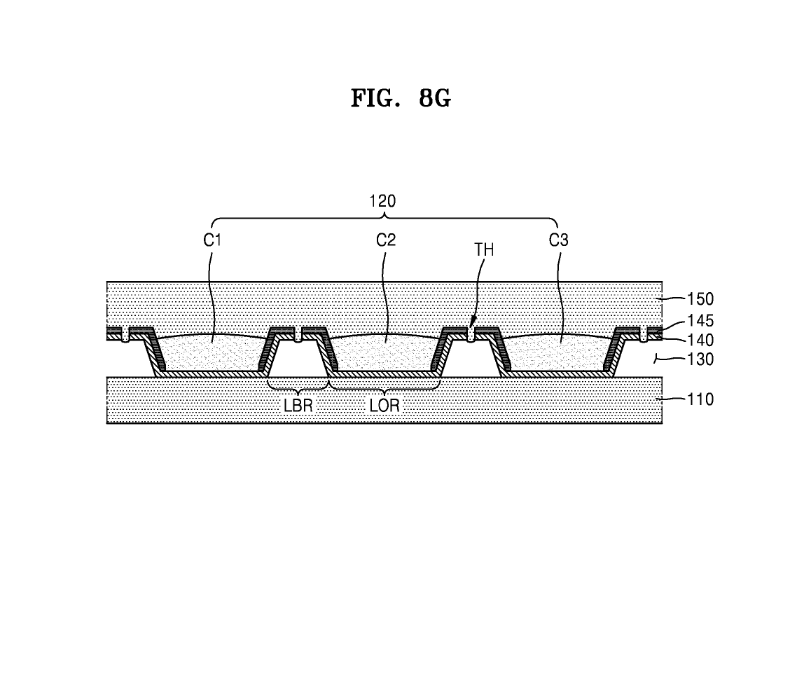

FIGS. 8A through 8G are cross-sectional views that illustrate a method of fabricating the backlight module of FIG. 6, according to an exemplary embodiment. FIGS. 8A through 8G show that sections of the through hole formed in the backlight module of FIG. 6 correspond to a section taken along a line VIII-VIII of FIG. 4.

Referring to FIG. 8B, according to an embodiment, the sacrificial pattern 115 is formed on the light guide panel 110 to define the light output region LOR and the light blocking region LBR. The sacrificial pattern 115 is formed on the light blocking region LBR of the light guide panel 110 and surrounds the light output region LOR. A side all of the sacrificial pattern 115 is tilted as illustrated in FIG. 8B. The sacrificial pattern 115 has a tapered section whose width decreases with increasing distance from the light guide panel 110.

According to an embodiment, the sacrificial pattern 115 is formed of a photosensitive organic material. For example, a photosensitive organic material layer can be coated on the light guide panel 110 by using a slit coating method or a spin coating method, and then the sacrificial pattern 115 that exposes the light output region LOR of the light guide panel 110 is formed by a photolithographic process. Due to characteristics of photolithographic processes, the sidewall of the sacrifice pattern 115 is tilted as illustrated in FIG. 8B.

According to another exemplary embodiment, as illustrated in FIG. 8A, a first sacrificial pattern 115p is formed on a center of the light blocking region LBR of the light guide panel 110. The first sacrificial pattern 115p exposes not only the light output region LOR but also an edge of the light blocking region LBR. The first sacrificial pattern 115p is formed just after a photolithographic process is performed on a photosensitive organic material layer. As illustrated in FIG. 8B, the sacrificial pattern 115 having tilted sidewalls can be formed by performing a temporary curing process on the first sacrificial pattern 115p.

Referring to FIG. 8C, according to an embodiment, a first interface layer 140′ and a first reflective layer 145′ are formed on the light guide panel 110 over the sacrificial pattern 115. Since the sacrificial pattern 115 protrudes upward from the flat light guide panel 110, as illustrated in FIG. 8C, a trench is formed by the first interface layer 140′ and the first reflective layer 145′ that corresponds to the light output region LOR. As illustrated in FIG. 8C, a width of the trench increases with increasing height from the light guide panel 110.

According to an embodiment, the first interface layer 140′ is formed of a material strong enough to sustain itself when the air gap 130 is formed in the first interface layer 140′. For example, the first interface layer 140′ is formed of silicon nitride.

According to an embodiment, the first reflective layer 145′ is formed of a light reflecting material, such as a metal. The first reflective layer 145′ may have a multi-layer structure in which a plurality of layers are successively stacked, or as illustrated in FIG. 7, may have a three-layer structure in which a first transparent metal oxide layer, a metal layer, and a second transparent metal oxide layer are successively stacked. The first interface layer 140′ and the first reflective layer 145′ may be formed by, for example, a CVD process.

Referring to FIG. 8D, according to an embodiment, the reflective layer 145 is formed by removing a part of the first reflective layer 145′. The reflective layer 145 exposes the first interface layer 140′ on the light output region LOR. The reflective layer 145 includes a through hole TH exposing a part of the first interface layer 140′ on the sacrificial pattern 115. As portions of the first reflective layer 145′ are removed, a depth of the trench of FIG. 8C increases.

Referring to FIG. 8E, according to an embodiment, a part of the first interface layer 140′ is removed and the interface layer 140, including the through hole TH, is formed. A part of the first interface layer 140′ exposed by the through hole TH of the reflective layer 145 is removed by using the reflective layer 145 as a mask. The through hole TH of the interface layer 140 is self-aligned by the through hole TH of the reflective layer 145. The sacrificial pattern 115 is externally exposed by the interface layer 140 and the through hole TH of the reflective layer 145. The sacrificial pattern 115 is removed by an etchant flowing thereon through the through hole TH. Therefore, the air gap 130 is formed in a space formed between the interface layer 140 and the light guide panel 110.

According to an embodiment, a step is generated by the interface layer 140 and the reflective layer 145 over the light guide panel 110, and a trench is formed, in which a lower surface of the trench is delimited by the interface layer 140 and a side surface of the trench is delimited by the reflective layer 145.

Referring to FIG. 8F, according to an embodiment, the color layer 120 that fills the trench is formed. The color layer 120 can be formed by an inkjet coating method, and a height of the reflective layer 145 to its upper surface is determined so that the color layer 120 does not flow into an adjacent trench when the color layer 120 is formed.

According to an embodiment, the first through third color layers C1 through C3 are formed in a predetermined position in a predetermined order because the first through third color layers C1 through C3 are formed of different materials. Since the color layer 120 is formed by an inkjet coating method, a photo process is not needed, which can reduce manufacturing costs and simplify the fabrication process.

Referring to FIG. 8G, according to an embodiment, the planarization layer 150 is formed to provide a flat surface on the light guide panel 110. The planarization layer 150 is formed on the color layer 120 and the reflective layer 145. The planarization layer 150 is formed of a transparent organic material, such as a polyimide resin, an acryl resin, or a resist material. The planarization layer 150 can be formed using a wet method, such as a slit coating method or a spin coating method, or a dry method, such as a CVD method or a vacuum deposition method. The planarization layer 150 is formed of an organic material having high viscosity, so that the planarization layer 150 does not flow into the air gap 130 through the through hole TH.

Next, according to an embodiment, the light source 190 is provided adjacent to the light guide panel 110. The light source 190 emits light incident to the inside of the light guide panel 110 through a side surface of the light guide panel 110.

FIG. 9 is a cross-sectional view of a part of a backlight module 100b according to another exemplary embodiment.

Referring to FIG. 9, according to an embodiment, the backlight module 100b includes the light guide panel 110, the light source 190, the color layer 120, the air gap 130, the planarization layer 150, an interface layer 140b, and the reflective layer 145.

According to an embodiment, since the light guide panel 110, the light source 190, the color layer 120, the air gap 130, the planarization layer 150, and the reflective layer 145 of the backlight module 100b are substantially respectively the same as the light guide panel 110, the light source 190, the color layer 120, the air gap 130, the planarization layer 150, and the reflective layer 145 of the backlight module 100a of FIG. 7, repeated descriptions thereof will be omitted.

According to an embodiment, although the backlight module 100a of FIG. 7 includes the third portion 143 of the interface layer 140 interposed between the color layer 120 and the light guide panel 110, the third portion 143 of the interface layer 140b is removed and the color layer 120 is directly disposed on the light output region LOR of the light guide panel 110.

As described above, according to an embodiment, a photolithographic process is used to form the structure of FIG. 8D to fabricate the backlight module 100a, and the photolithographic process is further used to form the structure of FIG. 8E. In the structure of FIG. 8D, the backlight module 100b has a part of the first interface layer 140′ removed using the reflective layer 145 as a mask, and thus, the interface layer 140b that exposes the light output region LOR of the light guide panel 110 with the through hole TH is formed. Next, the sacrifice pattern 115 is removed through the through hole TH, and the color layer 120 and the planarization layer 150 are sequentially formed, and therefore, the backlight module 100b may be formed.

Compared to fabricating the backlight module 100a, the number of photolithographic processes can be reduced by one when fabricating the backlight module 100b. Therefore, manufacturing costs may be reduced.

According to one or more exemplary embodiments, light efficiency can be improved by forming a light shielding layer using an air gap in a structure in which a light source is provided adjacent to a light guide panel. Furthermore, a reflective layer is formed using a sidewall of the light shielding layer, to reduce or prevent mixing of colored light emitted from a color layer that includes quantum dots and colored light emitted from a peripheral color layer. Also, a concave space is formed in a light output region by forming the light shielding layer, and a color layer is formed in the concave space using an inkjet coating method. Therefore, a fabrication process may be simplified. As a result, a display device having reduced manufacturing costs due to a simplified fabrication process, with lower power consumption due to improved light efficiency, and having improved color reproducibility by preventing color mixing, can be provided.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. A backlight module, comprising:
a light guide panel that includes a light output region and a light blocking region;
a light source that emits light to a side surface of the light guide panel;
a color layer disposed over the light output region that transmits colored light;
a planarization layer that covers the color layer on the light guide panel; and
an air gap provided between the light blocking region and the planarization layer.

2. The backlight module of claim 1, wherein
the air gap is provided directly on the light blocking region and surrounds side surfaces of the color layer.

3. The backlight module of claim 1, further comprising:
an interface layer that includes a first portion between the air gap and the color layer and a second portion between the air gap and the planarization layer, the interface layer delimiting side surfaces and an upper surface of the air gap wherein the second portion of the interface layer has a through hole, and the planarization layer directly contacts the air gap through the through hole.

4. The backlight module of claim 3, wherein
the interface layer further includes a third portion between the color layer and the light output region.

5. The backlight module of claim 3, wherein
the first portion of the interface layer is tilted wherein the color layer has a reverse-tapered section and a width of the first portion increases with increasing distance from the light guide panel.

6. The backlight module of claim 3, further comprising:
a reflective layer disposed between the first portion of the interface layer and the color layer and over the first and second portions of the interface layer.

7. The backlight module of claim 1, wherein
light emitted from the light source is white light, and
the color layer transmits colored light by absorbing wavelength bands of the white light incident thereon not being transmitted.

8. The backlight module of claim 1, wherein
light emitted from the light source has a first peak wavelength, and
the color layer comprises a color conversion layer that includes a plurality of quantum dots excited by the first peak wavelength light and that emit colored light having a second peak wavelength longer than the first peak wavelength, and a filter layer located between the color conversion layer and the planarization layer, wherein the filter layer absorbs the first peak wavelength light and transmits colored second peak wavelength light.

9. The backlight module of claim 8, wherein
the first peak wavelength light is blue light or ultraviolet light.

10. The backlight module of claim 1, wherein
the light output region includes first through third regions,
the color layer includes a first color layer on the first region that transmits first colored light, a second color layer on the second region that transmits second colored light, and a third color layer on the third region that transmits third colored light, and the air gap is located between the first through third color layers.

11. A display device, comprising:
a backlight module of claim 1;
a pixel array portion disposed on the planarization layer that includes a pixel electrode that overlaps the light output region and a pixel circuit that transmits a gray scale voltage to the pixel electrode;
a first polarizing plate on the planarization layer;
a liquid crystal layer on the first polarizing plate; and
a second polarizing plate on the pixel array portion.

12. A method of fabricating a backlight module, the method comprising:
forming a sacrificial pattern on a light guide panel, wherein the sacrificial pattern defines a light output region and a light blocking region on the light guide panel;
forming an interface layer that covers the sacrificial pattern on the light guide panel;
forming a through hole exposing an upper surface of the sacrificial pattern in the interface layer; and
removing the sacrificial pattern through the through hole to form an air gap wherein side surfaces and an upper surface of the air gap are delimited by the interface layer.

13. The method of claim 12, further comprising:
forming a color layer that emits colored light from light incident on the light output region;
forming a planarization layer on the color layer; and
providing a light source that emits light to a side surface of the light guide panel.

14. The method of claim 13, wherein
the color layer is formed by an inkjet coating method in a trench on the light output region defined by where the interface layer covers the air gap.

15. The method of claim 12, further comprising:
forming a reflective layer on the interface layer that covers at least a side surface of the sacrificial layer.

16. A backlight module comprising:
a light guide panel having a light output region and a light blocking region;
a color layer disposed over the light output region that transmits colored light;
an air gap disposed over the light blocking region; and
an interface layer comprising a first portion between the air gap and the color layer and a second portion over the air gap, the interface layer delimiting side surfaces and an upper surface of the air gap.

17. The backlight module of claim 16, further comprising:
a light source that emits light to a side surface of the light guide panel;
a planarization layer that covers the color layer on the light guide panel; and
the reflective layer disposed between the first portion of the interface layer and the color layer and over the first and second portions of the interface layer,
wherein the first portion of the interface layer is tilted wherein the color layer has a reverse-tapered section and a width of the first portion increases with increasing distance from the light guide panel,
the second portion of the interface layer is disposed between the air gap and the planarization layer and has a through hole, and the planarization layer directly contacts the air gap through the through hole.

18. The backlight module of claim 16, wherein
the interface layer further comprises a third portion between the color layer and the light output region.

19. The backlight module of claim 16, wherein
light emitted from the light source is white light, and
the color layer transmits colored light by absorbing wavelength bands of the white light incident thereon not being transmitted.

20. The backlight module of claim 16, wherein
light emitted from the light source has a first peak wavelength, and
the color layer comprises a color conversion layer that includes a plurality of quantum dots excited by the first peak wavelength light and that emit colored light having a second peak wavelength longer than the first peak wavelength, and a filter layer located between the color conversion layer and the planarization layer, wherein the filter layer absorbs the first peak wavelength light and transmits colored second peak wavelength light.
